(19) United States
(12) Patent Application Publication
(10) Pub. No.: US 2025/0077696 A1
(43) Pub. Date: Mar. 6, 2025

(54) SYSTEMS AND METHODS OF MANAGING AN INTERACTION WITH A LARGE LANGUAGE MODEL

(71) Applicants: Todd Marlin, Park City, UT (US); Marisa Marlin, Park City, UT (US)

(72) Inventors: Todd Marlin, Park City, UT (US); Marisa Marlin, Park City, UT (US)

(21) Appl. No.: 18/821,652

(22) Filed: Aug. 30, 2024

Related U.S. Application Data
(60) Provisional application No. 63/579,756, filed on Aug. 30, 2023.

(51) Int. Cl. G06F 21/62; G06N 3/0475

(52) U.S. Cl. CPC G06F 21/6218; G06N 3/0475

(57) ABSTRACT

The present disclosure provides a method of managing an interaction with a large language model (LLM). Further, the method may include receiving a prompt data from a user device associated with an organization. Further, the method may include receiving a policy data from an organization device associated with the organization. Further, the policy data may be associated with the organization. Further, the method may include analyzing the prompt data based on the policy data. Further, the method may include generating an output data based on the analyzing. Further, the generating may be based on the LLM. Further, the method may include storing each of the prompt data, the output data, and an identifier associated with one or more of the user device, the organization device, and the organization. Further, the method may include transmitting the output data to the user device.

### REFERENCE TO RELATED APPLICATIONS

This application claims the benefit of U.S. Provisional Patent Application No. 63/579,756, titled “METHODS AND SYSTEMS FOR FACILITATING BROWSING IN MULTI-PANED INTERFACE WITH GENERATIVE AI CHATBOTS”, filed Aug. 30, 2023, which is incorporated by reference herein in its entirety.

### FIELD OF THE INVENTION

The present invention relates generally to the field of data processing. More specifically, the present invention is systems and methods of managing an interaction with a large language model (LLM).

### BACKGROUND OF THE INVENTION

The field of data processing is technologically important to several industries, business organizations, and/or individuals. In particular, the use of data processing is prevalent for managing an interaction with a large language model (LLM).

Existing techniques for managing an interaction with a large language model (LLM) are deficient with regard to several aspects. For instance, current technologies allow interactions with LLMs. As a result, different technologies are needed that regulate the interactions with the LLMs. Furthermore, current technologies store histories of the interactions with the LLMs. As a result, different technologies are needed that store details of the interactions with the LLMs. Moreover, current technologies provide responses to prompts. As a result, different technologies are needed that provide additional information alongwith the responses.

Therefore, there is a need for improved systems and methods of managing an interaction with a large language model (LLM) that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of managing an interaction with a large language model (LLM). Further, the method may include receiving, using a communication device, a prompt data from a user device associated with an organization. Further, the method may include receiving, using the communication device, a policy data from an organization device associated with the organization. Further, the policy data may be associated with the organization. Further, the method may include analyzing, using a processing device, the prompt data based on the policy data. Further, the method may include generating, using the processing device, an output data based on the analyzing. Further, the generating may be based on the LLM. Further, the method may include storing, using a storage device, each of the prompt data, the output data, and an identifier associated with one or more of the user device, the organization device, and the organization. Further, the method may include transmitting, using the communication device, the output data to the user device.

The present disclosure provides a system of managing an interaction with a large language model (LLM). Further, the system may include a communication device. Further, the communication device may be configured for receiving a prompt data from a user device associated with an organization. Further, the communication device may be configured for receiving a policy data from an organization device associated with the organization. Further, the policy data may be associated with the organization. Further, the communication device may be configured for transmitting an output data to the user device. Further, the system may include a processing device communicatively coupled with the communication device. Further, the processing device may be configured for analyzing the prompt data based on the policy data. Further, the processing device may be configured for generating the output data based on the analyzing. Further, the generating may be based on the LLM. Further, the system may include a storage device communicatively coupled with the processing device. Further, the storage device may be configured for storing each of the prompt data, the output data, and an identifier associated with one or more of the user device, the organization device, and the organization.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of managing an interaction with a large language model (LLM), in accordance with some embodiments.

FIG. 4 illustrates a flowchart of a method 400 of managing an interaction with a large language model (LLM) including generating, using the processing device 1104, a citation data, in accordance with some embodiments.

FIG. 5 illustrates a flowchart of a method 500 of managing an interaction with a large language model (LLM) including analyzing, using the processing device 1104, the organization document, in accordance with some embodiments.

FIG. 6 illustrates a flowchart of a method 600 of managing an interaction with a large language model (LLM) including receiving, using the communication device 1102, a response data from the one or more external databases 1302, in accordance with some embodiments.

FIG. 7 illustrates a flowchart of a method 700 of managing an interaction with a large language model (LLM) including generating, using the processing device 1104, an audit trail data, in accordance with some embodiments.

FIG. 8 illustrates a flowchart of a method 800 of managing an interaction with a large language model (LLM) including generating, using the processing device 1104, an alert, in accordance with some embodiments.

FIG. 9 illustrates a flowchart of a method 900 of managing an interaction with a large language model (LLM) including replacing, using the processing device 1104, the sensitive data with the place-holder data in the prompt data, in accordance with some embodiments.

FIG. 10 illustrates a flowchart of a method 1000 of managing an interaction with a large language model (LLM) including receiving, using the communication device 1102, an approval data from the user device 1202, in accordance with some embodiments.

FIG. 11 illustrates a block diagram of a system 1100 of managing an interaction with a large language model (LLM), in accordance with some embodiments.

FIG. 12 illustrates a block diagram of the system 1100 of managing the interaction with the large language model (LLM), in accordance with some embodiments.

FIG. 13 illustrates a block diagram of the system 1100 of managing the interaction with the large language model (LLM), in accordance with some embodiments.

FIG. 14 is a flowchart of a method 1400 facilitating browsing through a multi-paned interface with generative AI (or artificial intelligence) chatbots, in accordance with some embodiments.

FIG. 15 is a flowchart of a method 1500 for facilitating browsing through a multi-paned interface with generative AI (or artificial intelligence) chatbots, in accordance with some embodiments.

FIG. 16 is a block diagram of a system 1600 facilitating browsing through a multi-paned interface with generative AI (or artificial intelligence) chatbots, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g., a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g., Windows, Mac OS, Unix, Linux, Android, etc.) in order to provide a user interface (e.g., GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g., username, password, passphrase, PIN, secret question, secret answer, etc.) and/or possession of a machine readable secret data (e.g., encryption key, decryption key, bar codes, etc.) and/or possession of one or more embodied characteristics unique to the user (e.g., biometric variables such as, but not limited to, fingerprint, palm-print, voice characteristics, behavioral characteristics, facial features, iris pattern, heart rate variability, evoked potentials, brain waves, and so on) and/or possession of a unique device (e.g., a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g., transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g., the server computer, a client device, etc.) corresponding to the performance of the one or more steps, environmental variables (e.g., temperature, humidity, pressure, wind speed, lighting, sound, etc.) associated with a device corresponding to the performance of the one or more steps, physical state and/or physiological state and/or psychological state of the user, physical state (e.g., motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g., a real-time clock), a location sensor (e.g., a GPS receiver, a GLONASS receiver, an indoor location sensor, etc.), a biometric sensor (e.g., a fingerprint sensor), an environmental variable sensor (e.g., temperature sensor, humidity sensor, pressure sensor, etc.) and a device state sensor (e.g., a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g., initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes systems and methods of managing an interaction with a large language model (LLM)

Further, the present disclosure describes methods and systems for facilitating browsing through a multi-paned interface with generative AI chatbots.

Further, the disclosed system may provide a browser-like experience with multiple panes (which may be turned on/off i.e., hidden not hidden) that enable a user to submit prompts 1 to as many generative artificial intelligence chatbots as the user may like. In addition, a separate pane may cover due diligence as related to the content.

### Navigation:

Back and forward
Favorite
Save Result
Remove result
Filter based on similarity of content

### Preferences:

Generative AI
   Connect directly to URL/API for gen AI engines (add as many as the user may like)
      Text
      Video
      Audio
      Image
      Client specific engine
   Set preferred algorithm usage
      Risk profile
      Assertions sourced
      Custom defined scoring
Search
   Connect to specific search engines to source assertions
File save preferences
   Define where and file type
Privacy
   Privacy preferences
Security
   Security preferences

Further, the multi-paned interface may include a left pane (generative AI content generation, ranking, review, and content adoption). Further, the disclosed system may allow the user to ability to submit a prompt. Further, the system may return results to prompt from 1 to N generative engines in rank order according to chosen sort preferences (i.e., algorithms) in a similar fashion to search engines. Further, the system may allow the user to click on a result and go to the result like a search engine, review content, and flag specific assertions for incorporation in specific.

### Right Pane (Due Diligence—Assertion Parse, Fact Check, Source Due Diligence):

Parses the assertions for the chosen content.
Sources and sub-sources assertions (from the internet and paid and free databases).
   Ability to source from 1 to N search engines.
   Ability to set APIs to pull source, sub source information (ex. Lexus, Thomson, PeopleLooker, etc.).
Identifies sources and sub-sources.
Uses third-party sites and databases to perform due diligence on a source or a sub source.

### Review Add-In (Review-Review Result, Select Assertions, Save Assertion to File and Associated Source/Fact Detail, and Corresponding Due Diligence):

These features can be used if you are using the left/pane right pane format (it would be enabled in the left pane if the content is browsed).
If the bottom pane is enabled, the top enables you to select a result or result and browse/review/etc. as if it were a doc and go back and forward between different results and take action.

### Bottom Pane (Content Viewer)—Optional Feature:

If enabled this pane goes across the bottom and enables you to review the content for a chosen result.
Ability to highlight, note, annotate, share, redline, redact, and save to external files.
   Include options for risk assessment, added metadata, source, and sub-source details.
   Ability to select identified assertions from multiple content files generated and save them to a new working document with any sourcing or metadata that may be added.

### Notebook:

The notebook can function as the editor if adopting content from any engine.
Document the results and associated risk assessment and sourcing (i.e., system of record).

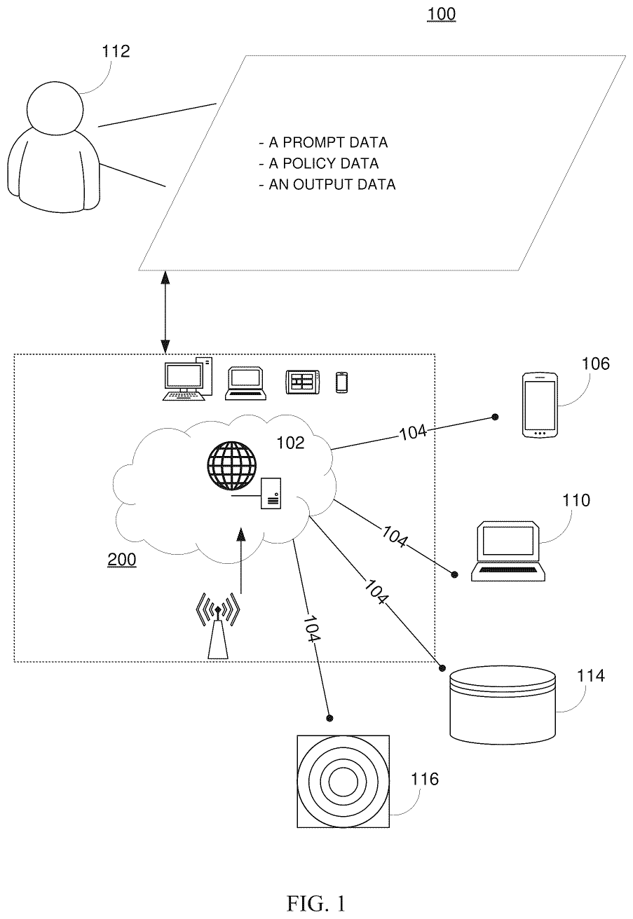

FIG. 1 is an illustration of an online platform 100 consistent with various embodiments of the present disclosure. By way of non-limiting example, the online platform 100 to facilitate managing an interaction with a large language model (LLM) may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, organizations, users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

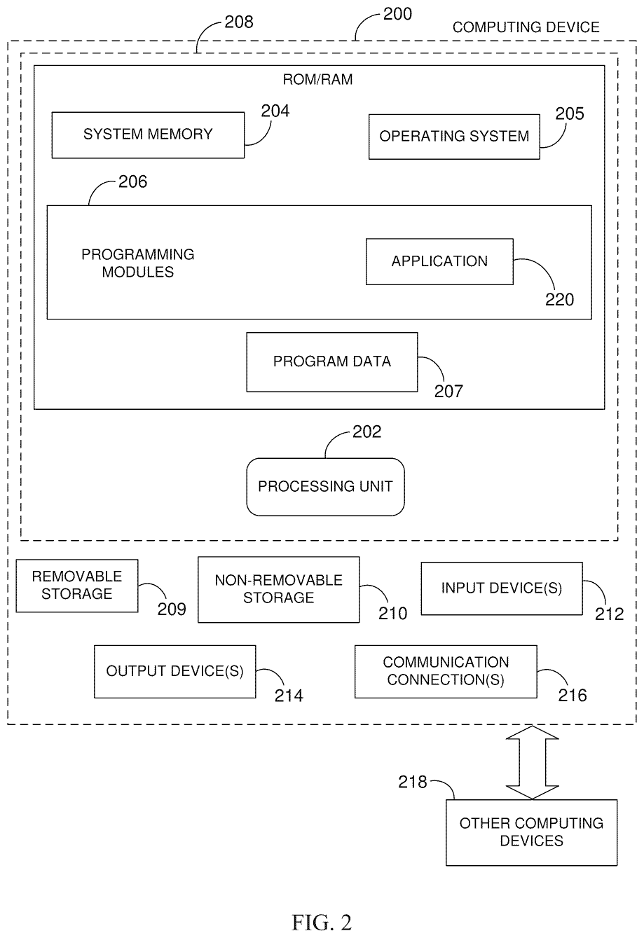

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g., random-access memory (RAM)), non-volatile (e.g., read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable, and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD), or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

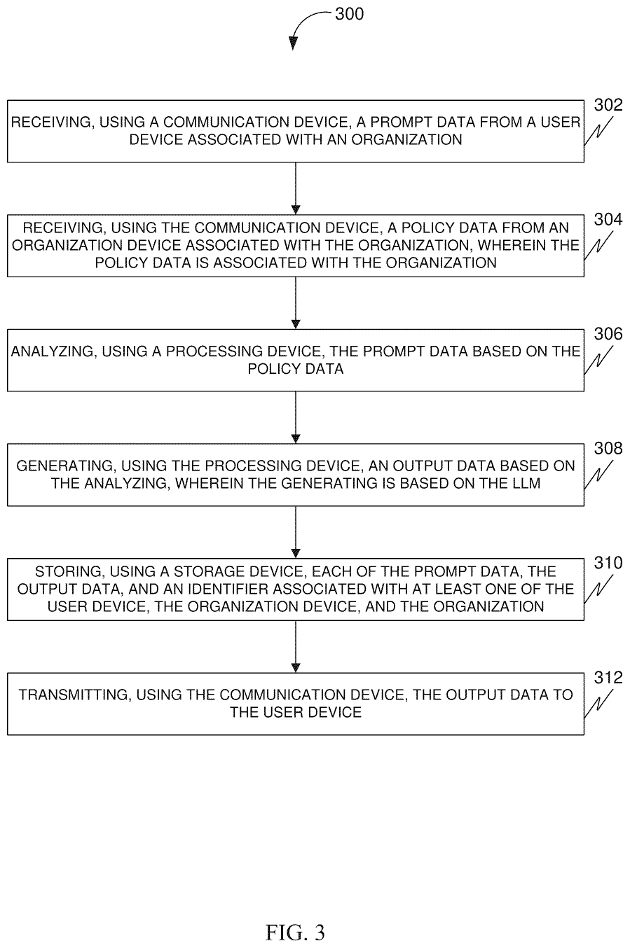

FIG. 3 illustrates a flowchart of a method 300 of managing an interaction with a large language model (LLM), in accordance with some embodiments.

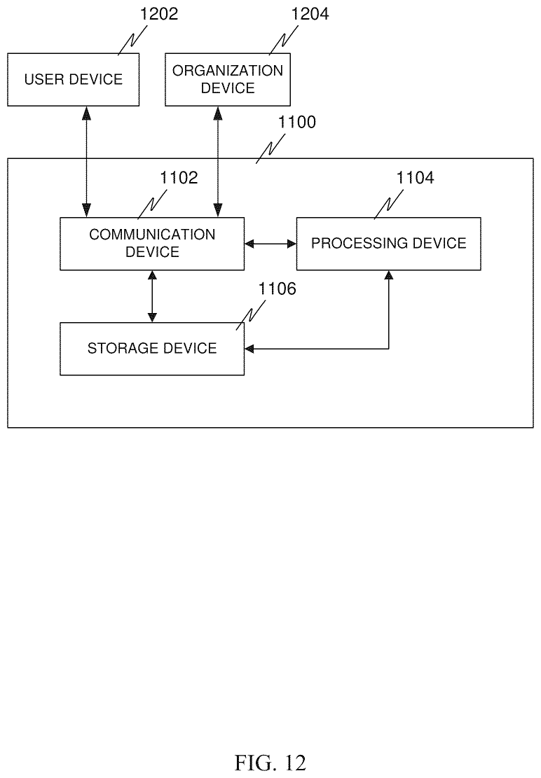

Accordingly, the method 300 may include a step 302 of receiving, using a communication device 1102, a prompt data from a user device 1202 (as shown in FIG. 12) associated with an organization. Further, the prompt data may be a prompt for large language models. Further, the prompt data may include a query, a question, etc. Further, the user device 1202 may include a computing device, a client device, a device, etc. Further, the organization may be a business entity, an educational entity, an institutional entity, an agency, a corporation, a company, etc. Further, the method 300 may include a step 304 of receiving, using the communication device 1102, a policy data from an organization device 1204 (as shown in FIG. 12) associated with the organization. Further, the organization device 1204 may include a computing device, a client device, a device, etc. Further, the policy data may include one or more policies, one or more rules, one or more regulations, one or more laws, one or more bylaws, one or more guidelines, one or more ethics, etc. Further, the policy data may be associated with the organization. Further, the method 300 may include a step 306 of analyzing, using a processing device 1104, the prompt data based on the policy data. Further, the method 300 may include a step 308 of generating, using the processing device 1104, an output data based on the analyzing. Further, the generating may be based on the LLM. Further, the LLM may include a generative pre-trained (GPT) model, a Bidirectional Encoder Representations from Transformers (BERT) model, an Embeddings from Language Model (ELMo), a bidirectional long short-term memory network (BILSTM) model, etc. Further, the method 300 may include a step 310 of storing, using a storage device 1106, each of the prompt data, the output data, and an identifier associated with one or more of the user device 1202, the organization device 1204, and the organization. Further, the identifier uniquely identifies one or more of the user device 1202, the organization device 1204, and the organization. Further, the identifier may include a user identifier, an organization identifier, a time stamp, a data stamp, a location stamp, a session identifier, etc. Further, the method 300 may include a step 312 of transmitting, using the communication device 1102, the output data to the user device 1202. Further, in an embodiment, the LLM may include a generative engine, a generative artificial intelligence (AI) chatbot, a generative artificial intelligence model, etc.

Further, in some embodiments, the method 300 may include a step of receiving, using the communication device 1102, at least one preference associated with the user from the user device 1202. Further, the method 300 may include a step of generating, using the processing device 1104, at least one instruction based on the at least one preference and the prompt data. Further, the at least one instruction may include a model indication of at least one of a plurality of large language models (LLMs). Further, the generating may be based on at least one of the plurality of LLMs based on the at least one instruction.

Further, in some embodiments, the LLM may include at least one large language model (LLM) and at least one machine learning (ML) model. Further, the at least one LLM may be connected with the at least one machine learning model. Further, the at least one machine learning model may be configured to be trained on a training data for determining parameters (such as a model parameter and a hyperparameter) of the at least one LLM for contexts. Further, the analyzing of the prompt data based on the policy data may include analyzing the prompt data using the at least one LLM and analyzing the policy data using the at least one ML model. Further, the at least one ML model may be configured for determining a context of the policy data. Further, the at least one ML modal may be configured for generating at least one value for at least one parameter of the at least one LLM. Further, the at least one LLM may be configured for adjusting the at least one parameter based on the at least one value of the at least one parameter. Further, the generating of the output data may be further based on the adjsuting of the at least one parameter.

Further, in some embodiments, the method 300 may include a step of

In some embodiments, the storing may be performed on a blockchain. Further, the each of the prompt data, the output data, and the identifier associated with one or more of the user device 1202, the organization device 1204, and the organization may be stored on at least one distributed ledger associated with the blockchain based on the performing of the storing on the blockchain. Further, the blockchain may include a private blockchain, a public blockchain, etc. Further, in an embodiment, the storing of the prompt data and the identifier may be performed on the blockchain using an asynchronous method. Further, in some embodiment, the method 300 may include a step of generating, using the processing device 1102, at least one additional identifier for the prompt data based on the performing of the storing on the blockchain. Further, the at least one additional identifier identifies an instance of the storing of the prompt data and the identifier on the blockchain and the prompt data and the identifier. Further, the method 300 may include a step of storing, using the storage device 1106, the at least one additional identifier on at least one database.

In some embodiments, the method 300 may include a step of storing, using the storage device 1106, a session identifier data in association with the prompt data. Further, the session identifier data may be associated with a session. Further, the prompt data may be received during the session. Further, the output data may be transmitted during the session. Further, the session identifier data uniquely identifies the session.

Further, in some embodiments, each of the prompt data and the output data may be at least one of a textual data, an image data, a video data, a sound data, and an abstract data.

Further, in some embodiments, the LLM includes a plurality of large language models (LLMs). Further, the output data may include a plurality of output data corresponding to the plurality of LLMs.

Further, in some embodiments, the policy data may include an indication of at least one sensitive data associated with the organization. Further, the at least one sensitive data may be sensitive to the organization. Further, the sensitive data may include data deemed by the organization to be sensitive.

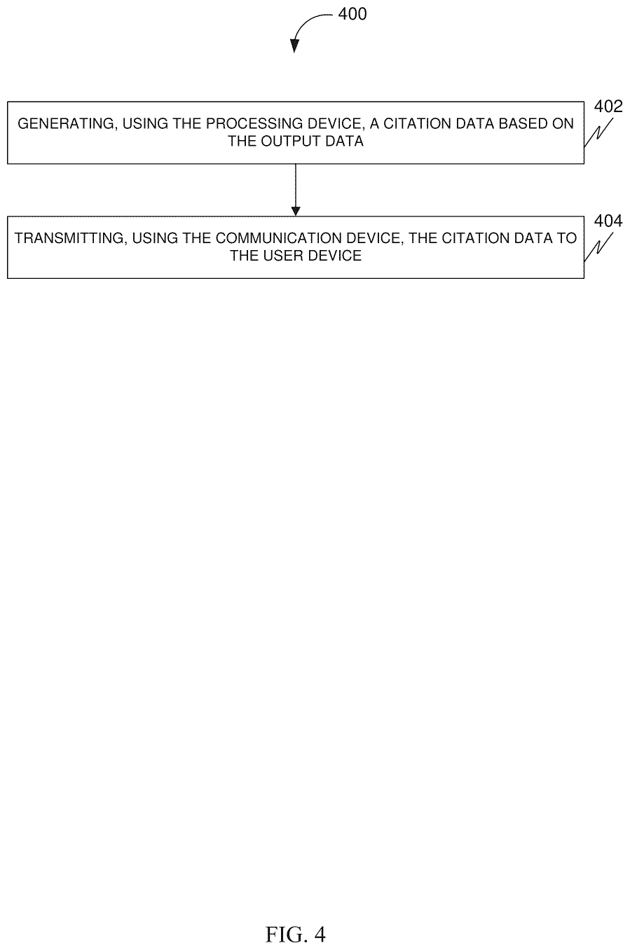

FIG. 4 illustrates a flowchart of a method 400 of managing an interaction with a large language model (LLM) including generating, using the processing device 1104, a citation data, in accordance with some embodiments.

Further, in some embodiments, the method 400 may include a step 402 of generating, using the processing device 1104, a citation data based on the output data. Further, the citation data may include references to aritcles, information sources, websites, books, research papers, etc. Further, in some embodiments, the method 400 may include a step 404 of transmitting, using the communication device 1102, the citation data to the user device 1202.

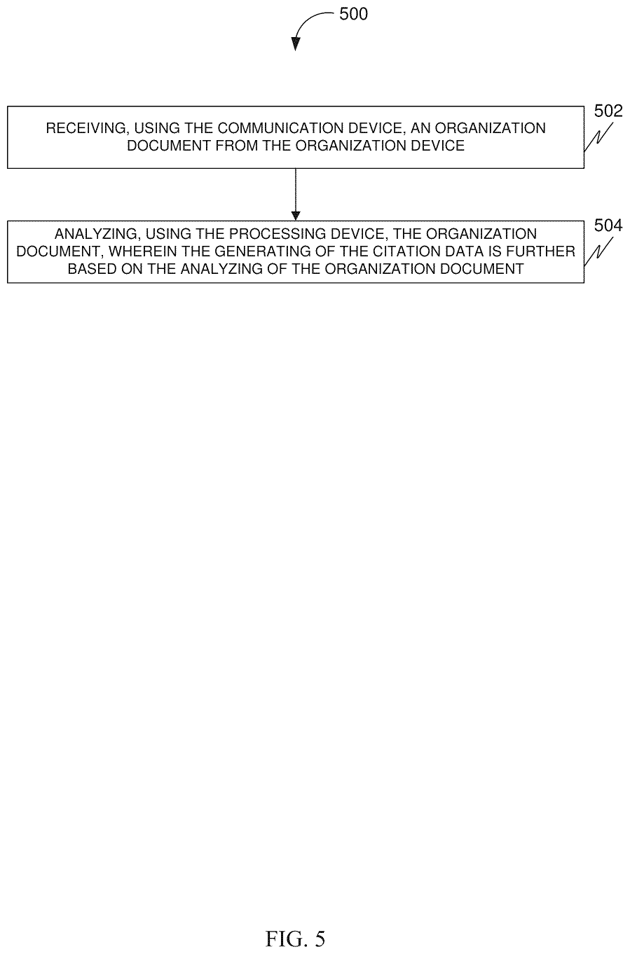

FIG. 5 illustrates a flowchart of a method 500 of managing an interaction with a large language model (LLM) including analyzing, using the processing device 1104, the organization document, in accordance with some embodiments.

Further, in some embodiments, the method 500 may include a step 502 of receiving, using the communication device 1102, an organization document from the organization device 1204. Further, the organization document may include information associated with the organization. Further, the organization document may include information of operations, businesses, accounts, products, whitepapers, etc. of the organization. Further, in some embodiments, the method 500 may include a step 504 of analyzing, using the processing device 1104, the organization document. Further, the generating of the citation data may be based on the analyzing of the organization document.

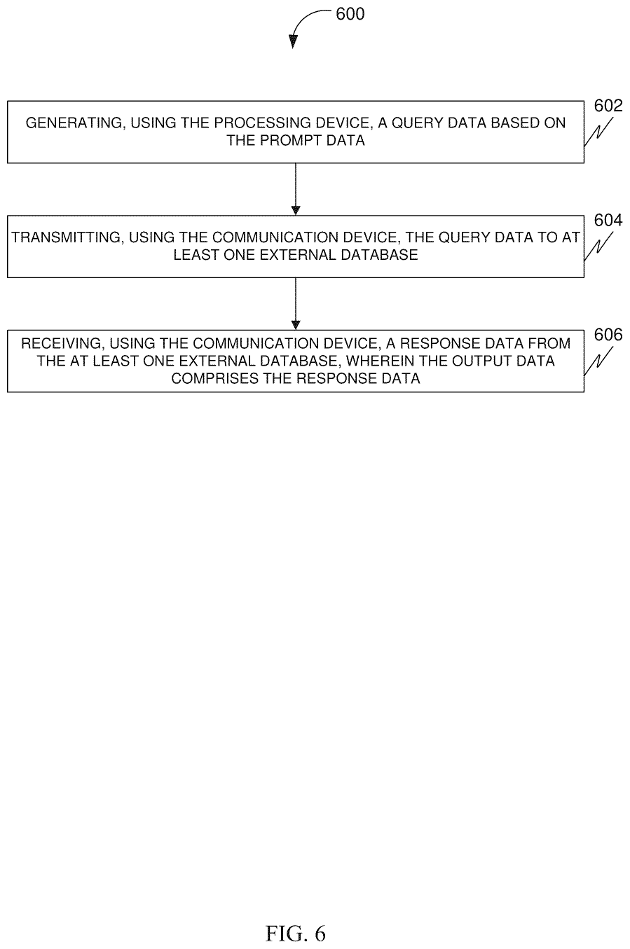

FIG. 6 illustrates a flowchart of a method 600 of managing an interaction with a large language model (LLM) including receiving, using the communication device 1102, a response data from the one or more external databases 1302, in accordance with some embodiments.

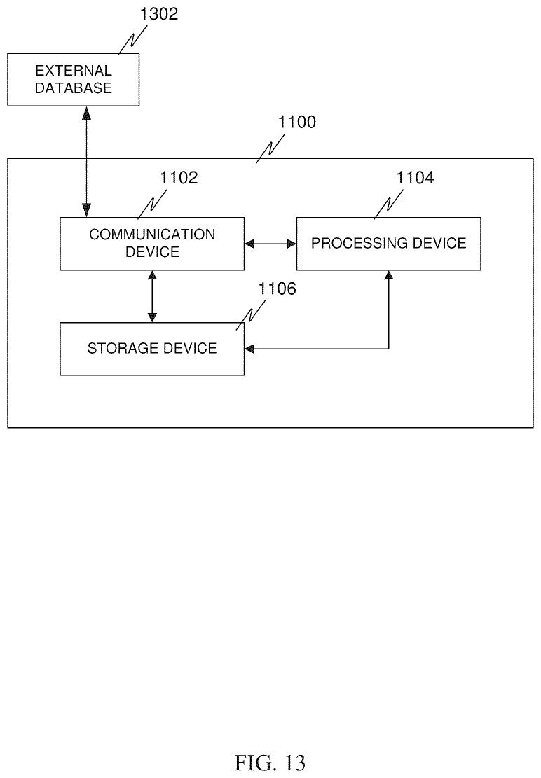

Further, in some embodiments, the method 600 may include a step 602 of generating, using the processing device 1104, a query data based on the prompt data. Further, in some embodiments, the method 600 may include a step 604 of transmitting, using the communication device 1102, the query data to one or more external databases 1302 (as shown in FIG. 13). Further, in some embodiments, the method 600 may include a step 606 of receiving, using the communication device 1102, a response data from the one or more external databases 1302. Further, the response data may be data obtained from the one or more external databases 1302 in response to the query data. Further, the one or more external databases 1302 may be databases, data sources, etc. Further, the output data includes the response data. Further, in an embodiment, the response data may include a positive citation data supporting an assertion in the output data and a negative citation data opposing the assertion in the output data.

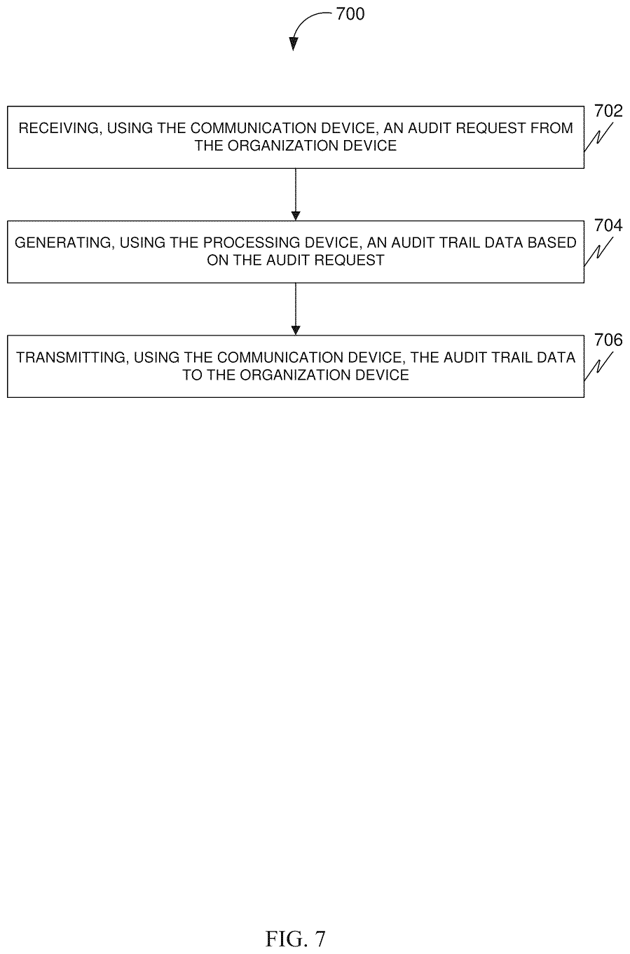

FIG. 7 illustrates a flowchart of a method 700 of managing an interaction with a large language model (LLM) including generating, using the processing device 1104, an audit trail data, in accordance with some embodiments.

Further, in some embodiments, the method 700 may include a step 702 of receiving, using the communication device 1102, an audit request from the organization device 1204. Further, in some embodiments, the method 700 may include a step 704 of generating, using the processing device 1104, an audit trail data based on the audit request. Further, in some embodiments, the method 700 may include a step 706 of transmitting, using the communication device 1102, the audit trail data to the organization device 1204.

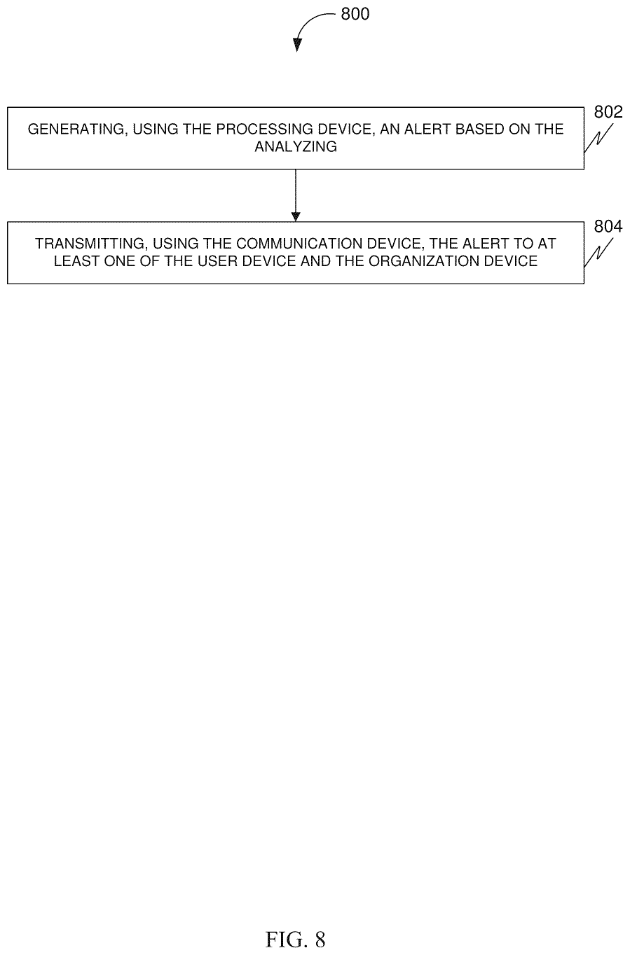

FIG. 8 illustrates a flowchart of a method 800 of managing an interaction with a large language model (LLM) including generating, using the processing device 1104, an alert, in accordance with some embodiments.

Further, in some embodiments, the method 800 may include a step 802 of generating, using the processing device 1104, an alert based on the analyzing. Further, in some embodiments, the method 800 may include a step 804 of transmitting, using the communication device 1102, the alert to one or more of the user device 1202 and the organization device 1204.

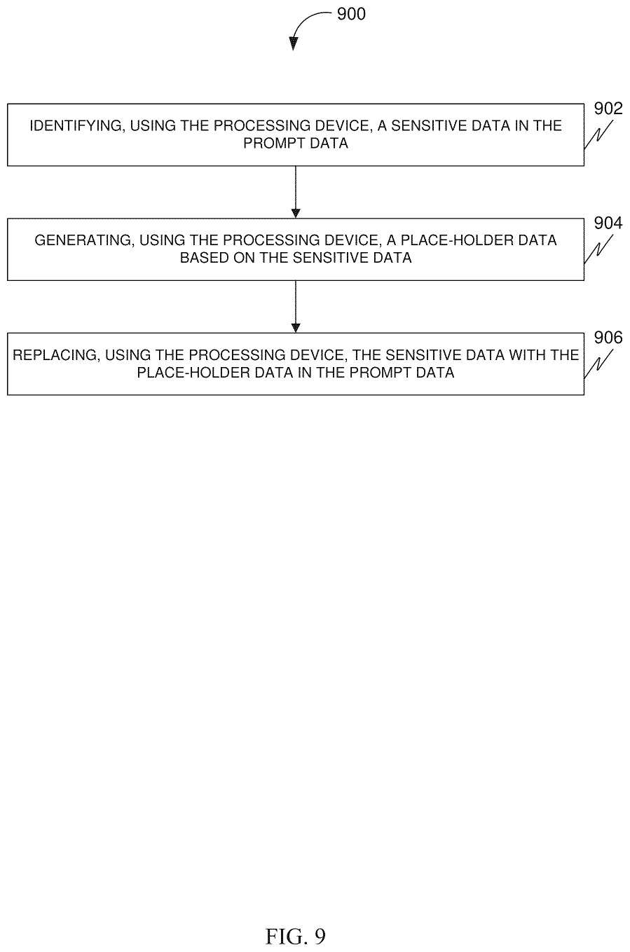

FIG. 9 illustrates a flowchart of a method 900 of managing an interaction with a large language model (LLM) including replacing, using the processing device 1104, the sensitive data with the place-holder data in the prompt data, in accordance with some embodiments.

Further, in some embodiments, the method 900 may include a step 902 of identifying, using the processing device 1104, a sensitive data in the prompt data. Further, the sensitive data may include phone numbers, social security numbers, bank account numbers, credit/debit card numbers, etc. Further, in some embodiments, the method 900 may include a step 904 of generating, using the processing device 1104, a place-holder data based on the sensitive data. Further, the place-holder data may include fake data that looks like the sensitive data in terms of characteristics (such as a format, a type, an apprearence, etc.). Further, in some embodiments, the method 900 may include a step 906 of replacing, using the processing device 1104, the sensitive data with the place-holder data in the prompt data.

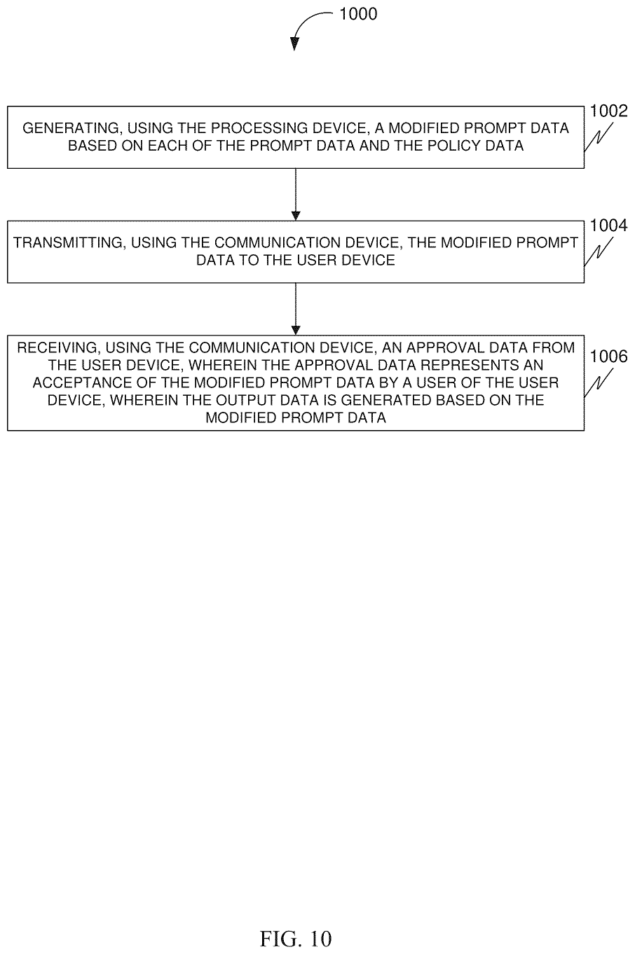

FIG. 10 illustrates a flowchart of a method 1000 of managing an interaction with a large language model (LLM) including receiving, using the communication device 1102, an approval data from the user device 1202, in accordance with some embodiments.

Further, in some embodiments, the method 1000 may include a step 1002 of generating, using the processing device 1104, a modified prompt data based on each of the prompt data and the policy data. Further, in some embodiments, the method 1000 may include a step 1004 of transmitting, using the communication device 1102, the modified prompt data to the user device 1202. Further, in some embodiments, the method 1000 may include a step 1006 of receiving, using the communication device 1102, an approval data from the user device 1202. Further, the approval data represents an acceptance of the modified prompt data by a user of the user device 1202. Further, the output data may be generated based on the modified prompt data.

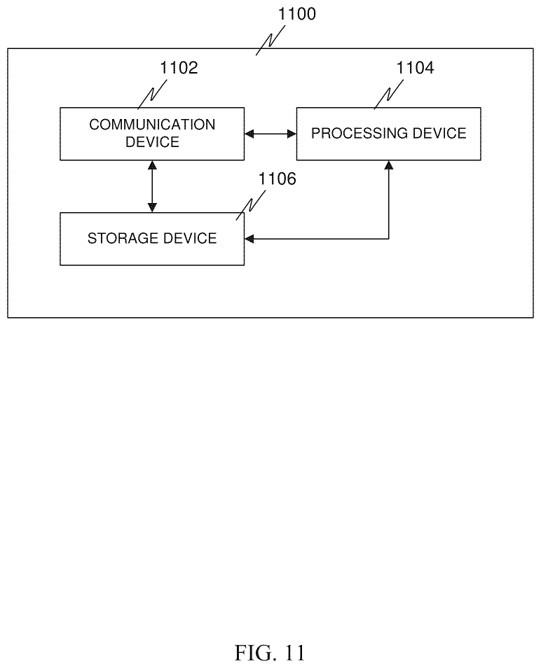

FIG. 11 illustrates a block diagram of a system 1100 of managing an interaction with a large language model (LLM), in accordance with some embodiments.

Accordingly, the system 1100 may include a communication device 1102. Further, the communication device 1102 may be configured for receiving a prompt data from a user device 1202, as shown in FIG. 12, associated with an organization. Further, the communication device 1102 may be configured for receiving a policy data from an organization device 1204, as shown in FIG. 12, associated with the organization. Further, the policy data may be associated with the organization. Further, the communication device 1102 may be configured for transmitting an output data to the user device 1202. Further, the system 1100 may include a processing device 1104 communicatively coupled with the communication device 1102. Further, the processing device 1104 may be configured for analyzing the prompt data based on the policy data. Further, the processing device 1104 may be configured for generating the output data based on the analyzing. Further, the generating may be based on the LLM. Further, the system 1100 may include a storage device 1106 communicatively coupled with the processing device 1104. Further, the storage device 1106 may be configured for storing each of the prompt data, the output data, and an identifier associated with one or more of the user device 1202, the organization device 1204, and the organization.

In some embodiments, the processing device 1104 may be configured for generating a citation data based on the output data. Further, the communication device 1102 may be configured for transmitting the citation data to the user device 1202.

In some embodiments, the communication device 1102 may be configured for receiving an organization document from the organization device 1204. Further, the processing device 1104 may be configured for analyzing the organization document. Further, the generating of the citation data may be based on the analyzing of the organization document.

Further, in some embodiments, the processing device 1104 may be configured for generating a query data based on the prompt data. Further, the communication device 1102 may be configured for transmitting the query data to one or more external databases 1302, as shown in FIG. 13. Further, the communication device 1102 may be further configured for receiving a response data from the one or more external databases 1302. Further, the output data includes the response data.

Further, in some embodiments, the communication device 1102 may be configured for receiving an audit request from the organization device 1204. Further, the communication device 1102 may be configured for transmitting an audit trail data to the organization device 1204. Further, the processing device 1104 may be configured for generating the audit trail data based on the audit request.

In some embodiments, the processing device 1104 may be configured for generating an alert based on the analyzing. Further, the communication device 1102 may be configured for transmitting the alert to one or more of the user device 1202 and the organization device 1204.

In some embodiments, the storing may be performed on a blockchain.

In some embodiments, the storage device 1106 may be further configured for storing a session identifier data in association with the prompt data.

Further, in some embodiments, the processing device 1104 may be configured for identifying a sensitive data in the prompt data. Further, the processing device 1104 may be configured for generating a place-holder data based on the sensitive data. Further, the processing device 1104 may be configured for replacing the sensitive data with the place-holder data in the prompt data.

Further, in some embodiments, the processing device 1104 may be configured for generating a modified prompt data based on each of the prompt data and the policy data. Further, the communication device 1102 may be configured for transmitting the modified prompt data to the user device 1202. Further, the communication device 1102 may be configured for receiving an approval data from the user device 1202. Further, the approval data represents an acceptance of the modified prompt data by a user of the user device 1202. Further, the output data may be generated based on the modified prompt data.

FIG. 12 illustrates a block diagram of the system 1100 of managing the interaction with the large language model (LLM), in accordance with some embodiments.

FIG. 13 illustrates a block diagram of the system 1100 of managing the interaction with the large language model (LLM), in accordance with some embodiments.

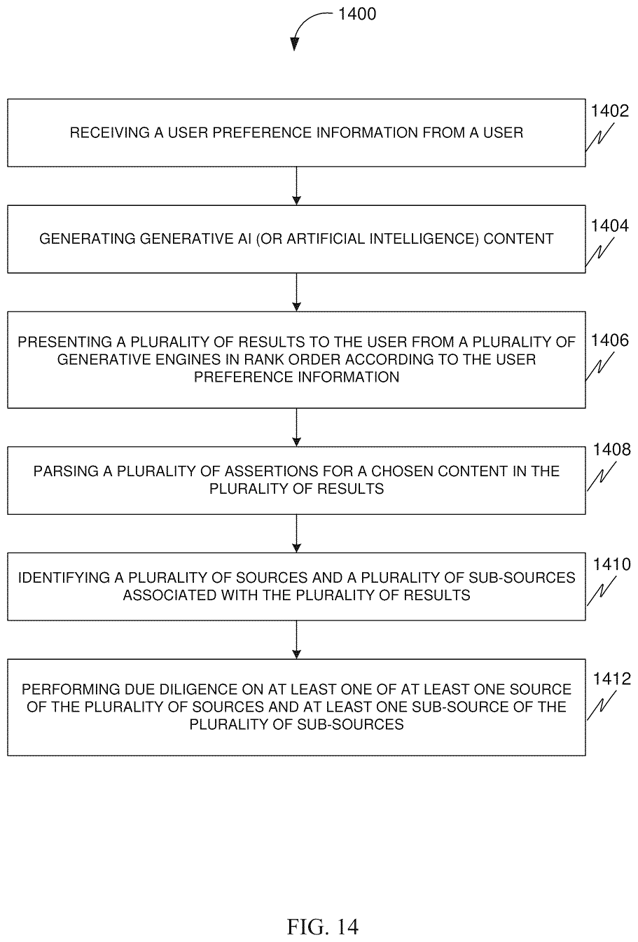

FIG. 14 is a flowchart of a method 1400 facilitating browsing through a multi-paned interface with generative AI (or artificial intelligence) chatbots, in accordance with some embodiments.

Further, the method 1400 may include a step 1402 of receiving a user preference information from a user. Further, the user preference information may include a generative AI searching information that may include a text, a video, an audio, an image, a client-specific image. Further, the generative AI searching information may include an algorithm information that may include a risk profile, an assertion sourced, and a custom-defined scoring. Further, the generative AI searching information may include a search engine information associated with a search engine to source assertion. Further, the user preference information may include a privacy preference information and a security preference information.

Further, the method 1400 may include a step 1404 of generating generative AI (or artificial intelligence) content.

Further, the method 1400 may include a step 1406 of presenting a plurality of results to the user from a plurality of generative engines in rank order according to the user preference information.

Further, the method 1400 may include a step 1408 of parsing a plurality of assertions for a chosen content in the plurality of results.

Further, the method 1400 may include a step 1410 of identifying a plurality of sources and a plurality of sub-sources associated with the plurality of results.

Further, the method 1400 may include a step 1412 of performing due diligence on at least one of at least one source of the plurality of sources and at least one sub-source of the plurality of sub-sources.

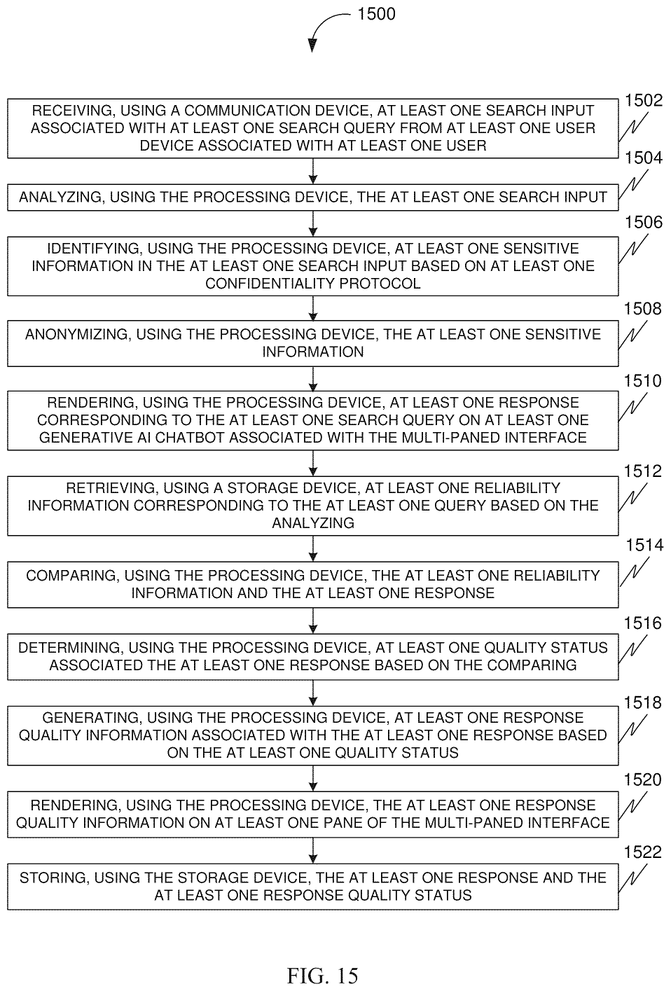

FIG. 15 is a flowchart of a method 1500 for facilitating browsing through a multi-paned interface with generative AI (or artificial intelligence) chatbots, in accordance with some embodiments.

Further, the method 1500 may include a step 1502 of receiving, using a communication device, at least one search input associated with at least one search query from at least one user device associated with at least one user. Further, the at least one user device may include, but may not be limited to, a smartphone, a laptop, a desktop, a tablet computer, etc.

Further, the method 1500 may include a step 1504 of analyzing, using a processing device, the at least one search input.

Further, the method 1500 may include a step 1506 of identifying, using the processing device, at least one sensitive information in the at least one search input based on at least one confidentiality protocol.

Further, the method 1500 may include a step 1508 of anonymizing, using the processing device, the at least one sensitive information.

Further, the method 1500 may include a step 1510 of rendering, using the processing device, at least one response corresponding to the at least one search query on at least one generative AI chatbot associated with the multi-paned interface. Further, the at least one response may be generated using at least one generative AI model trained on a dataset using at least one algorithm configured for natural language interpreting and responding.

Further, the method 1500 may include a step 1512 of retrieving, using a storage device, at least one query response information corresponding to the at least one query based on the analyzing.

Further, the method 1500 may include a step 1514 of comparing, using the processing device, the at least one query response information and the at least one response.

Further, the method 1500 may include a step 1516 of determining, using the processing device, at least one quality status associated the at least one response based on the comparing. Further, the at least one quality status may include, but may not be limited to, a fact check, a rank, a review result, etc.

Further, the method 1500 may include a step 1518 of generating, using the processing device, at least one response quality information associated with the at least one response based on the at least one quality status.

Further, the method 1500 may include a step 1520 of rendering, using the processing device, the at least one response quality information on at least one pane of the multi-paned interface.

Further, the method 1500 may include a step 1522 of storing, using the storage device, the at least one response and the at least one response quality status.

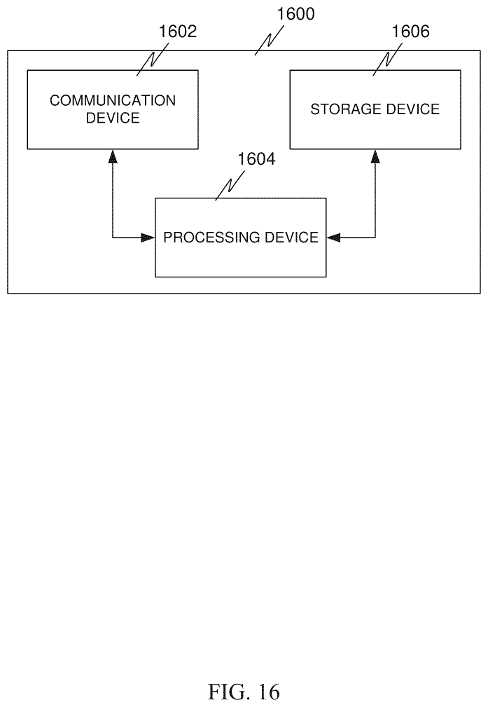

FIG. 16 is a block diagram of a system 1600 facilitating browsing through a multi-paned interface with generative AI (or artificial intelligence) chatbots, in accordance with some embodiments. Accordingly, the system 1600 may include a communication device 1602, a processing device 1604, and a storage device 1606. Further, the storage device 1606 may be communicatively coupled with the processing device 1604. Further, the storage device 1606 may be communicatively coupled with the communication device 1602. Further, the communication device 1602 may be communicatively coupled with the processing device 1604.

Further, the communication device 1602 may be configured for receiving at least one search input associated with at least one search query from at least one user device associated with at least one user. Further, the at least one user device may include, but may not be limited to, a smartphone, a laptop, a desktop, a tablet computer, etc.

Further, the processing device 1604 may be configured for analyzing the at least one search input. Further, the processing device 1604 may be configured for identifying, using the processing device, at least one sensitive information in the at least one search input based on at least one confidentiality protocol. Further, the processing device 1604 may be configured for anonymizing, using the processing device, the at least one sensitive information. Further, the processing device 1604 may be configured for rendering at least one response corresponding to the at least one search query on at least one generative AI chatbot associated with the multi-paned interface. Further, the at least one response may be generated using at least one generative AI model trained on a dataset using at least one algorithm configured for natural language interpreting and responding. Further, the processing device 1604 may be configured for comparing at least one query response information and the at least one response. Further, the processing device 1604 may be configured for determining at least one quality status associated the at least one response based on the comparing. Further, the at least one quality status may include, but may not be limited to, a fact check, a rank, a review result, etc. Further, the processing device 1604 may be configured for generating at least one response quality information associated with the at least one response based on the at least one quality status. Further, the processing device 1604 may be configured for rendering the at least one response quality information on at least one pane of the multi-paned interface.

Further, the storage device 1606 may be configured for retrieving the at least one query response information corresponding to the at least one query based on the analyzing. Further, the storage device 1606 may be configured for storing the at least one response and the at least one response quality information.

### Aspects

In terms of aspect 1, a method of managing an interaction with a large language model (LLM), the method comprises the steps of: receiving, using a communication device, at least one prompt data from at least one user device associated with at least one user; analyzing, using a processing device, the at least one prompt data; identifying, using the processing device, at least one organization associated with the at least one user device; obtaining, using the processing device, at least one policy data of the at least one organization based on the identifying of the at least one organization; modifying, using the processing device, the at least one prompt data based on the at least one policy data; generating, using the processing device, at least one modified prompt data based on the modifying; transmitting, using the communication device, the at least one modified prompt data to at least one large language model (LLM) device, wherein the at least one LLM device is configured for generating at least one output data for the at least one modified prompt data by using at least one large language model (LLM) based on the at least one modified prompt; receiving, using the communication device, the at least one output data from the at least one LLM device; generating, using the processing device, at least one user response data based on the at least one output data, wherein the at least one user response data comprises at least a portion of the at least one output data; transmitting, using the communication device, the at least one user response data to the at least one user device; and storing, using a storage device, the at least one prompt data.

In terms of aspect 2, the method of aspect 1 further comprises the steps of: generating, using the processing device, at least one identifier associated with at least one of the at least one user device, and the at least one organization based on the analyzing of the at least one prompt data; and storing, using the storage device, the at least one identifier in association with the at least one prompt data.

In terms of aspect 3, the method of aspect 1 further comprising the step of: modifying, using the processing device, the at least one output data based on the at least one policy data, wherein the generating of the at least one user response data is further based on the modifying of the at least one output data.

In terms of aspect 4, the method of aspect 1 further comprises steps of: generating, using the processing device, at least one query data based on the analyzing of the at least one prompt data; executing, using the processing device, a search in at least one external database based on the at least one query data; and obtaining, using the processing device, at least one response data from the at least one external database based on the executing, wherein the generating of the at least one user response data is further based on the at least one response data.

In terms of aspect 5, the method of aspect 1 further comprises steps of: generating, using the processing device, at least one organization query data based on the analyzing of the at least one prompt data; executing, using the processing device, a search in at least one organization database based on the at least one organization query data; obtaining, using the processing device, at least one organization document from the at least one organization database based on the executing; analyzing, using the processing device, the at least one organization document; and generating, using the processing device, at least one citation data for the at least one output data based on the analyzing of the at least one organization document, wherein the generating of the at least one user response data is further based on the at least one citation data, wherein the at least one user response data comprises the at least one citation data.

In terms of aspect 6, the method of aspect 1 further comprises steps of: receiving, using the communication device, at least one audit request from at least one organization device associated with the at least one organization; identifying, using the processing device, at least one of one or more requested prompt data and one or more requested identifiers based on the at least one audit request; analyzing, using the processing device, at least one of the one or more requested prompt data and the one or more requested identifiers; generating, using the processing device, at least one audit trail data based on the analyzing of at least one of the one or more requested prompt data and the one or more requested identifiers; and transmitting, using the communication device, the at least one audit trail data to the at least one organization device.

In terms of aspect 7, the method of aspect 1 further comprises the step of: generating, using the processing device, at least one of an instruction and a context for the at least one large language model based on the analyzing of the at least one prompt data, wherein the modifying of the at least one prompt data comprises incorporating at least one of the instruction and the context with the at least one prompt data, wherein the generating of the at least one modified prompt data is further based on the incorporating, wherein the at least one modified prompt data comprises the at least one prompt data and at least one of the instruction and the context.

In terms of aspect 8, the method of aspect 7 further comprises the steps of: generating, using the processing device, at least one prompt query data based on the analyzing of the at least one prompt data; executing, using the processing device, a search in at least one first external database based on the at least one prompt query data; and obtaining, using the processing device, at least one first response data from the at least one first external database based on the executing; analyzing, using the processing device, the at least one first response data, wherein the generating of at least one of the instruction and the context for the at least one large language model is further based on the analyzing of the at least one first response data.

In terms of aspect 9, the method of aspect 1 further comprising receiving, using the communication device, at least one large language model (LLM) data associated with the at least one LLM from the at least one LLM device, wherein the modifying of the at least one prompt data is further based on the at least one LLM data.

In terms of aspect 10, the method of aspect 1, wherein the at least one LLM device comprises the at least one LLM.

Although the invention has been explained in relation to its preferred embodiment, it is to be understood that many other possible modifications and variations can be made without departing from the spirit and scope of the invention as hereinafter claimed.

What is claimed is:

1. A method of managing an interaction with a large language model (LLM), the method comprising:
receiving, using a communication device, a prompt data from a user device associated with an organization;
receiving, using the communication device, a policy data from an organization device associated with the organization, wherein the policy data is associated with the organization;
analyzing, using a processing device, the prompt data based on the policy data;
generating, using the processing device, an output data based on the analyzing, wherein the generating is based on the LLM;
storing, using a storage device, each of the prompt data, the output data, and an identifier associated with at least one of the user device, the organization device, and the organization; and
transmitting, using the communication device, the output data to the user device.

2. The method of claim 1 further comprising:
generating, using the processing device, a citation data based on the output data; and
transmitting, using the communication device, the citation data to the user device.

3. The method of claim 2 further comprising:
receiving, using the communication device, an organization document from the organization device; and
analyzing, using the processing device, the organization document, wherein the generating of the citation data is further based on the analyzing of the organization document.

4. The method of claim 1 further comprising:
generating, using the processing device, a query data based on the prompt data;
transmitting, using the communication device, the query data to at least one external database; and
receiving, using the communication device, a response data from the at least one external database, wherein the output data comprises the response data.

5. The method of claim 1 further comprising:
receiving, using the communication device, an audit request from the organization device;
generating, using the processing device, an audit trail data based on the audit request; and
transmitting, using the communication device, the audit trail data to the organization device.

6. The method of claim 1 further comprising:
generating, using the processing device, an alert based on the analyzing; and
transmitting, using the communication device, the alert to at least one of the user device and the organization device.

7. The method of claim 1, wherein the storing is performed on a blockchain.

8. The method of claim 1 further comprising storing, using the storage device, a session identifier data in association with the prompt data.

9. The method of claim 1 further comprising:
identifying, using the processing device, a sensitive data in the prompt data;
generating, using the processing device, a place-holder data based on the sensitive data; and
replacing, using the processing device, the sensitive data with the place-holder data in the prompt data.

10. The method of claim 1 further comprising:
generating, using the processing device, a modified prompt data based on each of the prompt data and the policy data;
transmitting, using the communication device, the modified prompt data to the user device; and
receiving, using the communication device, an approval data from the user device, wherein the approval data represents an acceptance of the modified prompt data by a user of the user device, wherein the output data is generated based on the modified prompt data.

11. A system of managing an interaction with a large language model (LLM), the system comprising:
a communication device configured for:
receiving a prompt data from a user device associated with an organization;
receiving a policy data from an organization device associated with the organization, wherein the policy data is associated with the organization; and
transmitting an output data to the user device;
a processing device communicatively coupled with the communication device, wherein the processing device is configured for:
analyzing the prompt data based on the policy data; and
generating the output data based on the analyzing, wherein the generating is based on the LLM; and
a storage device communicatively coupled with the processing device, wherein the storage device is configured for storing each of the prompt data, the output data, and an identifier associated with at least one of the user device, the organization device, and the organization.

12. The system of claim 11, wherein the processing device is further configured for generating a citation data based on the output data, wherein the communication device is further configured for transmitting the citation data to the user device.

13. The system of claim 12, wherein the communication device is further configured for receiving an organization document from the organization device, wherein the processing device is further configured for analyzing the organization document, wherein the generating of the citation data is further based on the analyzing of the organization document.

14. The system of claim 11, wherein the processing device is further configured for generating a query data based on the prompt data, wherein the communication device is further configured for:
transmitting the query data to at least one external database; and
receiving a response data from the at least one external database, wherein the output data comprises the response data.

15. The system of claim 11, wherein the communication device is further configured for:
receiving an audit request from the organization device; and
transmitting an audit trail data to the organization device, wherein the processing device is further configured for generating the audit trail data based on the audit request.

16. The system of claim 11, wherein the processing device is further configured for generating an alert based on the analyzing, wherein the communication device is further configured for transmitting the alert to at least one of the user device and the organization device.

17. The system of claim 11, wherein the storing is performed on a blockchain.

18. The system of claim 11, wherein the storage device is further configured for storing a session identifier data in association with the prompt data.

19. The system of claim 11, wherein the processing device is further configured for:
identifying a sensitive data in the prompt data;
generating a place-holder data based on the sensitive data; and
replacing the sensitive data with the place-holder data in the prompt data.

20. The system of claim 11, wherein the processing device is further configured for generating a modified prompt data based on each of the prompt data and the policy data, wherein the communication device is further configured for:
transmitting the modified prompt data to the user device; and
receiving an approval data from the user device, wherein the approval data represents an acceptance of the modified prompt data by a user of the user device, wherein the output data is generated based on the modified prompt data.
